(19) United States
(12) Patent Application Publication
(10) Pub. No.: US 2009/0160768 A1
(43) Pub. Date: Jun. 25, 2009

(54) Enhanced Presentation Capabilities Using a Pointer Implement

(75) Inventor: Rakesh Kumar, Hyderabad (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 11/962,136

(22) Filed: Dec. 21, 2007

(51) Int. Cl. G06F 3/033; H04N 9/31

(52) U.S. Cl. 345/158; 348/744; 348/E09.025

(57) ABSTRACT

Providing enhanced presentation capabilities using a pointer implement. In an embodiment, a user operates a key on a pointer implement to cause the pointer implement to capture the display image on a screen and send the captured image frame to a digital processing system. The digital processing system examines the image frame to determine the location of a beam spot caused by the pointer implement, which can be used as a basis for several user features. For example, a user may cause the digital processing system to draw a line on the screen or use the pointer implement as a mouse as well.

### BACKGROUND

1. Field of Disclosure

The present disclosure relates generally to pointer implements and more specifically to providing enhanced presentation capabilities using such implements.

2. Related Art

Presentation entails display of pre-specified content, typically on a large screen, while a person (presenter) usually talks in relation to the displayed content. Presentations enable presenters to organize their thoughts (or content sought to be communicated) using various tools such as PowerPoint™ software from Microsoft and other software packages, and then present organized content to several audience using a digital processing system.

Many of the presentations often include sounds and graphics type content also, to enhance the presentation experience. Similarly, while some presentations permit only static content (in which the same content of a slide is continued to be displayed until the user requests a change to another slide), many presentations often contain dynamic content (including animations, video, information downloaded in real-time, etc.).

Pointer implements are often used by presenters to point to specific portions of a displayed content. A pointer implement often refers to a component which projects a light beam in a direction specified by the presenter. Assuming the light is incident on the displayed content, the point of incidence helps the presenter focus the audience attention to a desired portion.

For example, a pointer device may contain a tip/end from which a beam of light emanates when a user presses an on button, and the user thus simply moves the pointer device in a desired direction and cause the light to be focused on the content displayed.

The presenter is thus able to super-impose light on the content caused to be displayed by a digital processing system. Accordingly, the effective content displayed to audience is the combined display caused by the digital processing system and the pointer device.

Such a feature may be useful when a presently displayed content has several pieces of information, and it is desirable to point to specific portion of a displayed content. Thus, the user points the light beam (in the above illustrative example) to the desired specific portion to draw the audience's attention to these portions.

It is generally desirable that the presenters be provided with enhanced presentation capabilities using such implements.

### BRIEF DESCRIPTION OF THE DRAWINGS

Example embodiments will be described with reference to the following accompanying drawings, which are described briefly below.

FIG. 1 is a block diagram illustrating an example environment in which several aspects of the present invention may be implemented.

FIG. 2 is a flowchart illustrating the manner in which a digital processing system processes images received from a pointer implement, in an embodiment of the present invention.

FIG. 3 is diagram illustrating some example keys to provide various user features in an embodiment of the present invention.

FIGS. 4A-4D depict the manner in which a presenter may draw persistent shapes (lines) on screen 140 according to an aspect of the present invention.

FIGS. 5A-5D depict the manner in which corresponding keys on a handheld may be operated as left click and right click buttons of a mouse, according to an aspect of the present invention.

FIG. 6 is a block diagram illustrating an architecture of a digital processing system, in one embodiment of the present invention.

FIG. 7 is a block diagram illustrating an architecture for a handheld (example pointer implement), in an embodiment of the present invention.

FIG. 8 is a block diagram illustrating the details of a digital processing system in which several aspects of the present invention may be implemented.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present invention, a digital processing system examines an image frame to determine the location of a beam spot. The beam spot may be formed by a pointer implement on a screen, which also displays the images generated by an application executing on the digital processing system. Such a feature can be used to provide several user features, as described below.

According to another aspect of the present invention a user can operate a pointer implement to draw a desired pattern on a display screen. In an embodiment, the user operates a key to indicate that visual marks are to be included at the specific locations corresponding to the beam spot. The digital processing system ensures that the visual marks are present at each of such indicated locations. The indicated locations can form a line.

According to one more aspect of the present invention, the pointer implement can be used as a mouse. In an embodiment, the user operates a key to indicate a mouse action (e.g., click or menu open/close) at the location corresponding to the beam spot. The digital processing system may internally generate a mouse event to cause the corresponding appropriate action performed.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

2. Example Environment

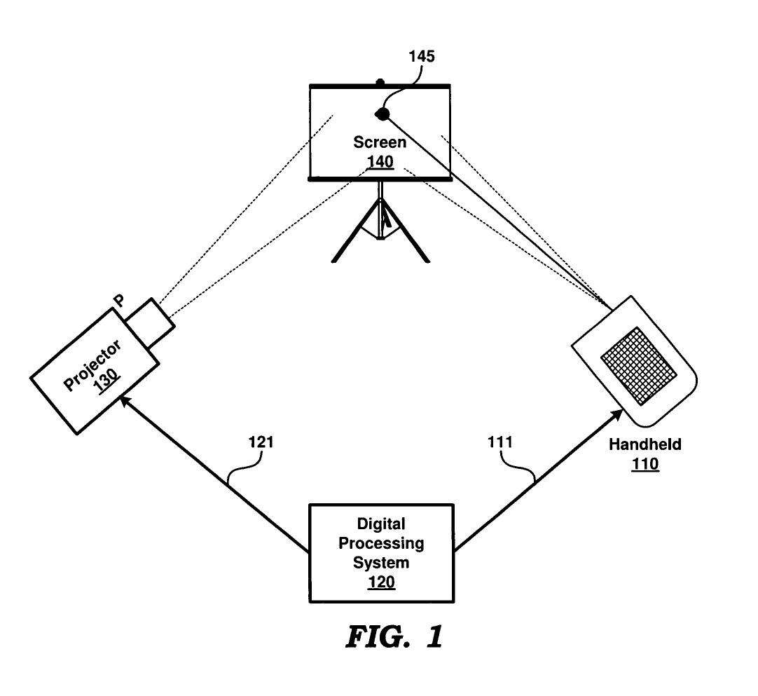

FIG. 1 is a block diagram of an example environment in which several aspects of the present invention may be implemented. The example environment there is shown containing handheld 110 (example of a pointer implement providing enhanced presentation capabilities according to several aspects of the present invention), digital processing system 120, projector 130, and screen 140. Each block is described below in detail.

The block diagram is shown containing only representative systems for illustration. However, real-world environments may contain more/fewer/different systems/components/blocks, both in number and type, depending on the purpose for which the environment is designed, as will be apparent to one skilled in the relevant arts.

Screen 140 represents a surface which images may be projected for viewing. The projected images are usually larger in a larger size compared to the images formed by digital processing system 120. The image displayed on screen 140 is referred to as a display image and contains the system images (formed by digital processing system 120 and projected by projector 130).

Projector 130 represents a device which may project images onto a screen such as screen 140. Projector 130 receives the (system) images to be projected from digital processing system 120 over path 121 and forms light signals, which when are incident on screen 140 creates the projected image. Projector 130 and screen 140 may be implemented in a known way.

Digital processing system 120 represents a system which receives data from handheld 110 over path 111 and processes the data according to several aspects of the present invention as described below with examples. Path 111 may be implemented as a wireless link using well known protocols, for example, wireless LAN (Local Area Network) protocols such as IEEE 802.11 from the Institute of Electrical and Electronics Engineers, wireless USB, etc. Alternately, path 111 may also use a wired link such as USB, etc. Digital processing system 120 provides the images (system image) being projected by projector 130 on screen 140 over path 121, using a video cable or other wired or wireless communication links, using well known techniques.

Handheld 110 represents an example pointer implement in which several aspects of the present invention may be implemented. Handheld 110 contains a source, capable of producing a beam of light, such as a laser pointer, well known in the relevant arts. The beam of light illuminates a spot (beam spot) 146 on screen 140 and may be used by a presenter to point to specific portions of a presentation. It should be understood that the beam spot can be formed using any technologies, though various colors of laser is often known to be used.

Handheld 110 may also contain a camera (not shown) which can be used to capture display images (the image projected by projector 130 onto screen 140 and the beam point if present), displayed on screen 140 and the captured images may be transferred to digital processing system 120 over a wireless or wired link (path 111). It should be appreciated that the camera can be provided external to handheld 110 (e.g., as a part of or attached to digital processing system 120) in alternative embodiments.

Digital processing system 120 may process the data representing such images according to an aspect of the present invention, as described below with examples.

3. Processing Images Received from a Pointer Implement

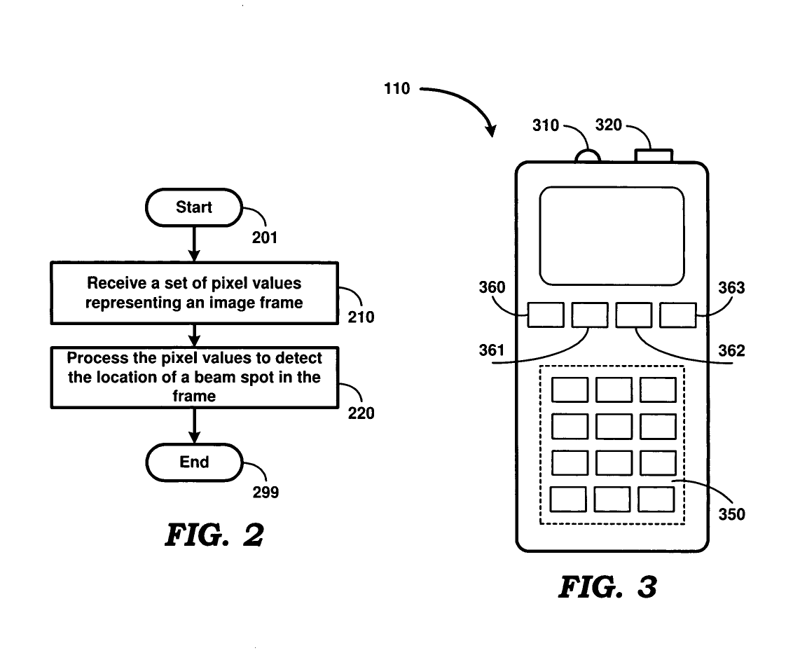

FIG. 2 is a flowchart illustrating the manner in which a digital processing system processes images received from a pointer implement, in an embodiment of the present invention. The flowchart is described with respect to FIG. 1 merely for illustration. However, various features can be implemented in other environments and with other components. Furthermore, the steps are described in a specific sequence merely for illustration.

Alternative embodiments in other environments, using other components, and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, digital processing system 120 receives a set of pixel values representing an image frame. Each pixel may represent the corresponding color and intensity of a corresponding point/pixel on the image frame using conventions such as YUV, RGB, etc. The extent of area represented by each pixel generally depends on the resolution of camera within handheld 110 and/or any further processing of the captured image within (to artificially enhance or reduce) handheld 110 prior to sending an image frame to digital processing system 120. Each image frame (display image) may be formed by super-imposition of a system image projected by projector 130 and the beam spot caused by the pointer implement.

In step 220, digital processing system 120 processes the pixel values to detect the location of a beam spot in the frame. In general, the image frame needs to be examined for a pattern matching the expected characteristics (shape, intensity, color of pixels, etc.) of the beam spot. The expected characteristics may be determined based on processing associated with prior image frames, user configuration, etc. The detection is typically simplified when there is substantial contrast of the beam spot in relationship with the rest of the frame, and accordingly the light (source) in the pointer implement may accordingly be chosen to provide for such contrast.

The processing to detect the location of a beam spot may be carried out in a known way and the location of the beam spot may be specified according to a convention such as in terms of pixel coordinates (e.g., pixel with coordinates (300,315) in an image frame having 800×600 pixels). The location can be detected as a single point or an area covered by the beam spot. In case of an area, the multiple pixel coordinates can be specified with individual coordinates or as a shape with corresponding dimensions (e.g., a circle with 2 pixels of radius around a centre at a particular coordinate location). The flowchart ends in step 299.

By having the ability to detect the location of a beam spot, the user of a pointer implement may be provided with user level features. In examples described above, the user is provided with the ability to draw persistent lines on screen 140 (super-imposing on the application image frames generated by a presentation application to produce a system image provided to projector 130 for projecting onto screen 140), and operate the pointer implement as a mouse.

It may be desirable to provide control to the user on the specific durations/instances at which the features are operative. According to an aspect of the present invention, handheld 110 is enhanced with additional keys to provide such control to the user, as described below with examples.

4. Additional Keys in Handheld

FIG. 3 is diagram illustrating some example keys to provide various user features in an embodiment of the present invention. Handheld 110 there is shown with laser pointer 310, camera 320, portion 350 and keys 360-363.

Laser source 310 represents a source of light capable of producing a beam of light. A presenter may point handheld 110 such that the beam of light may form a beam spot at a desired location on the display image on screen 140. The beam of light or other excitations can be used to produce the beam spot described below (e.g., using laser).

Camera 320 captures images as pixel values constituting image frames. Camera 320 is physically located in handheld 110 such that when a presenter points handheld 110 at a spot (such as a portion of display image on screen 140) with the light beam produced by laser source 310, eye of camera 320 also points in the same direction. As a result, the image on screen 140 can be captured when the user points the pointer implement at the screen.

Thus, camera 320 is located and configured such that when a presenter is pointing at a display image on screen 140 with handheld 110, camera 320 is able to capture the complete display image on screen 140, and provide the captured image as a image frame.

Portion 350 represents various keys that may be present for other user features provided by the handheld. For example, assuming handheld 110 can operate as a mobile phone, keys may be present to dial a desired number, answer a call, operate various menus, adjust voice level, etc. Similarly, assuming handheld 110 can also operate as a music player, additional keys may be present for playing a song, forwarding, reversing, moving to next/previous track, etc.

Key 360 can be operated to turn on/off laser source 310 that can be focused at a desired point by a presenter. The key can operate as a toggle switch which turns the source on and off respectively upon operation (e.g., pressing) of the key each time. Each of the keys can be provided in any suitable form (e.g., a button which can be pressed/released, slided to different positions, etc.). The operation of the key depends on the corresponding design and generally needs to provide at least for the states described below.

Key 361, when operated, causes camera 320 in handheld 110 to capture an image, in the direction of the eye of camera 320. As noted above, the eye generally points in the same direction as the light beam and thus the images captured generally represent the larger area (display image on screen 140, including the beam spot if present) containing the beam spot.

As described below in further detail, key 361 can be pressed/operated by a user to cause the corresponding beam spot to be displayed as a persistent point in image frames thereafter, according to an aspect of the present invention. It should be appreciated that the beam spot caused by a pointer implement is generally non-persistent in that the beam spot disappears soon after the beam is moved away from the beam spot.

On the other hand, when the user presses key 361, by operation of an aspect of the present invention, the beam spot persists, implying that the display on screen 140 continues to retain the image point corresponding to the beam spot (when key 361 was pressed) even though the beam spot is no longer on the image point.

The user can keep key 361 pressed and move the beam spot along a desired pattern, to cause a line of the same pattern to be displayed in a persistent manner on screen 140. For each of the points of the pattern, the flowchart of FIG. 2 is operative to detect the location of the beam spot. The pattern can be any desired pattern (curve, crooked line, straight line, etc.)

Keys 362 and 363 respectively operate as left click and right click buttons that are commonly provided on various commercially available mouses (e.g., model SMOP1310 Anyzen, available from Samsung). However, additional keys can be provided to support more complex mouses in alternative embodiments.

The manner in which a user can draw a persistent line using key 361 in an example scenario is described next.

5. Drawing a Persistent Line

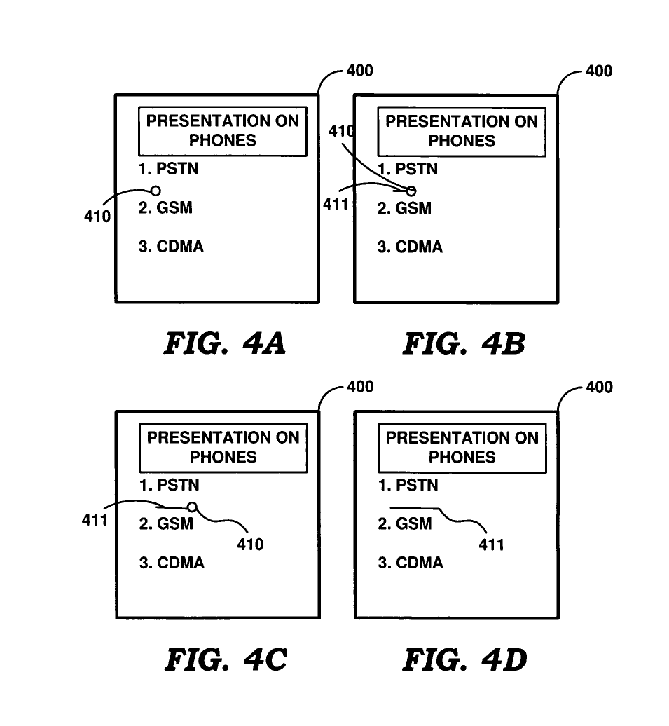

FIGS. 4A-4D depict the manner in which a presenter may draw persistent shapes (lines) on screen 140 according to an aspect of the present invention. Each of the Figures represents a display image/screen at a corresponding time instant. These images are representative snapshots in a sequence of successive images, as will be apparent from the description below. Further, point 410 represents the beam spot (if present) in each image, and line 411 (if present) represents the persistent line superimposed on the system image generated by digital processing system 120.

The figures correspond to a scenario in which light beam is on (by operation of button 360), button 361 is pressed (causing the capture of image frames by handheld 110 and transfer of the image frames to digital processing system 120), and the user is drawing a shape on the display image on screen 140 using the light beam.

FIG. 4A contains display image 400 with a system image received from projector 130 superimposed with the beam spot received from handheld 110.

In FIG. 4B, the presenter is shown to have moved beam spot 410 to the right and a persistent line 411 may be observed on the path followed by beam spot 410.The system image again contains all of the display image 400 except the beam spot. Persistent line 411 is included, assuming that the user has operated key361 when the beam spot was at each of the points of persistent line 411.

In FIG. 4C, the presenter is shown to have moved beam spot 410 further right and line 411 is shown to have increased in length accordingly. In FIG. 4D, the presenter is shown to have completed drawing the shape (underlining the item of interest i.e. “1. PSTN”) in the presentation on screen 140, and has switched off the light beam by pressing key 360. Therefore, beam spot 410 is not seen.

However, line 411 is visible (persistent), as it is super-imposed on an application image by digital processing system 120 to generate the system image projected by projector 130, as described above. In an embodiment, line 411 may remain visible on screen 140 till the presenter changes the presentation (slide) being projected (thus changing the application image). In other words, when the user application (or the underlying operating environment) changes the display output, the persistent line 411 may be removed from the new displayed image. It may be appreciated that the super-imposed line (such as line 411) may be changed/erased in a number of other ways as well.

The manner in which a presenter may operate corresponding keys on handheld 110 as left click and right click buttons of a mouse in an example scenario is described next.

6. Operation of Pointer Implement as a Mouse

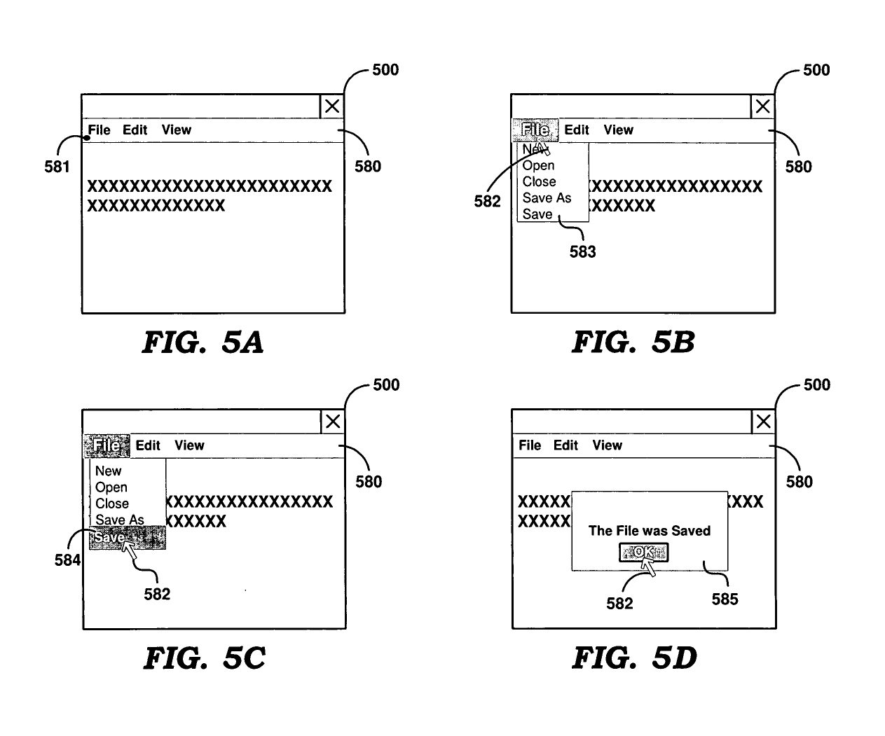

FIGS. 5A-5D depict the manner in which corresponding keys on a handheld may be operated as left click and right click buttons of a mouse, according to an aspect of the present invention. Each of the Figures represents a display image/screen at a corresponding time instant. These images are representative snapshots in a sequence of successive images, as will be apparent from the description below. Further, point 581 represents the beam spot (if present) in each image, and icon 582 (if present) represents a mouse cursor superimposed by digital processing system 120 on the application image generated, according to an aspect of the present invention.

FIGS. 5A to 5D correspond to a scenario in which the light beam is on (by operation of key 360), key 362 is being used as the left mouse button (when key 362 is pressed, a control signal is sent to digital processing system 120 which, according to an aspect of the present invention, is interpreted to mean that left mouse button is clicked), and a presenter is interacting with an application executing in digital processing system 120.

In FIG. 5A, the presenter is shown pointing beam spot 581 to the “File” menu in menu area 510 of display image 500. FIG. 5B represent a snapshot of display image 500 at an instant after the presenter has pressed key 362 on handheld 110 (corresponding to a left mouse button click), while beam spot 581 was at the location as shown in FIG. 5A.

Beam spot 581 is shown having changed to an icon 582 representing a mouse cursor, and the drop down menu 583 corresponding to “File” is shown (caused by clicking of the left mouse button on “File” resulting in selection of “File” from menu area 510).

In FIG. 5C, the presenter is shown to have moved the mouse (by moving the beam of light from handheld 110 and operating the corresponding key 362 at that point) to save 584 menu selection of drop down menu 583.

FIG. 5D represent a snapshot at an instant after the presenter has pressed key 362 on handheld 110 (corresponding to a left mouse button click), while mouse cursor 582 was at the location 584 as shown in FIG. 5C (thus selecting save 584 from dropdown menu 583). The application is shown displaying a message 585, after completing the save 584 action.

Thus, it may be appreciated that a presenter may, using a pointer implement, draw persistent lines as desired on a presentation on screen 140 (display image) and also use the pointer implement a s mouse, according to several aspects of the present invention. The description is continued with the architecture of digital processing system 120, enabling such enhancements according to an embodiment of the present invention.

7. Digital Processing System Architecture

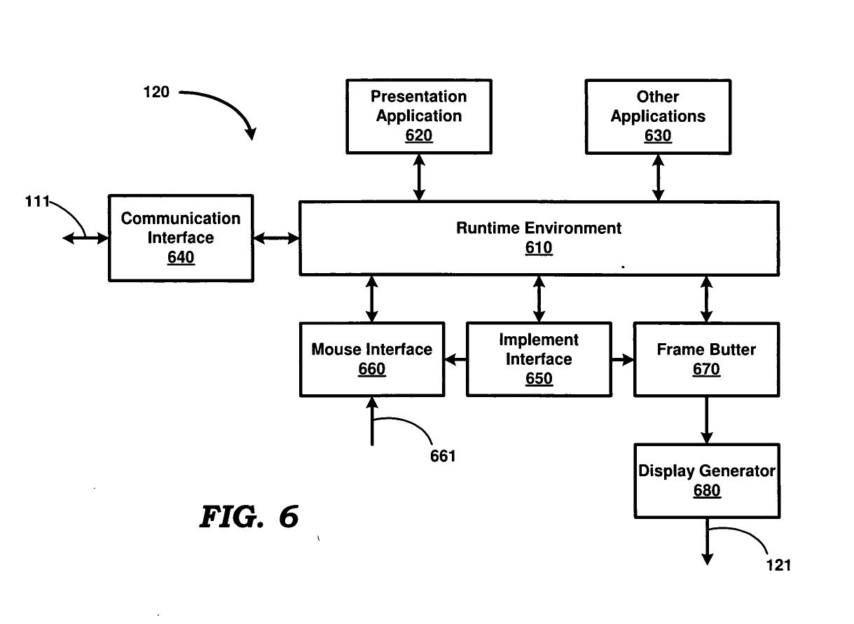

FIG. 6 is a block diagram illustrating the architecture of a digital processing system, in one embodiment of the present invention. Digital processing system 120 is shown containing runtime environment 610, presentation application 620, other applications 630, communication interface 640, implement interface 650, mouse interface 660, frame buffer 670 and display generator 680. Each block is described in further detail below.

Again, merely for illustration, only representative number/types of blocks are shown in FIG. 6. However, architecture of a digital processing system according to several aspects of the present invention can contain many more/fewer/different blocks, both in number and type, depending on the purpose for which the environment is designed, as will be apparent to one skilled in the relevant arts.

Presentation Application 620 represents a user application such as PowerPoint™ from Microsoft which enables a presenter to organize his thoughts and present organized content to several audience using digital processing system 120, projector 130 and screen 140, as described above. It should however be appreciated that the application images generated by other types (directed for different purposes such as drawings, word processing, spread sheets, etc.) of user applications (e.g., other applications 630, described below) can also be used for making presentations.

Other applications 630 correspond to various applications such as word processors, multimedia applications (for example, music players), calendars and schedulers, calculators, messaging applications, etc., executing in digital processing system 120, to provide the desired user experience. In general, each application provides for user interaction by providing an output (e.g., text/graphics display, sound, video, etc.) and receives inputs such as mouse clicks and key strokes.

Communication interface 640 interfaces with handheld 110 over path 111 to receive pixel values representing image frames as well as control signals (generated by keys 361-363 on handheld 110, when pressed). Communication interface 640 may contain various protocol stacks (such as IP stack, etc.) and software routines and calls which are necessary for the transfer of digital values between digital processing system 120 and handheld 110. The pixel values and control signals received by communication interface 640 is passed on to run time environment 610, which provides it to implement interface 650 for processing.

Mouse interface 660 interfaces with pointing devices such as a mouse connected to digital processing system 120 and receives the signals corresponding to pointing device actions such as mouse click, mouse movement, etc., over path 661 and provides the signals to runtime environment 610. It should be appreciated that mouse refers to any device which permits a user to point to specific portion of a display screen (in conjunction with a cursor) and indicate an action (by pressing the corresponding key offered in the mouse).

In addition, mouse interface 660 receives the control signals (generated by keys 362-363 on handheld 110, when pressed and received by implement interface 650 through run time environment 610 and communication interface 640) and the location of the beam spot when the key press (of keys 362-363) occurred, from implement interface 650 and generates a mouse event corresponding to the key presses (left click for key 362 and right click for key 363 in the illustrative examples) at the respective location of the beam spot. The mouse event so generated is passed to run time environment 610, for providing to the respective application (presentation application 620, other applications 630, etc.) requesting for a user input.

Frame buffer 670 represents a buffer which holds the values (color, brightness, other attributes, etc.) of each of the pixels to be displayed by digital processing system 120. As may be appreciated, the pixels together define the system image eventually sent for display on path 121. All applications which desire to display an output invoke corresponding display interfaces in runtime environment 610 to writes the corresponding pixel values in the appropriate locations of frame buffer 670.

Display generator 680 generates display signals on path 121 corresponding to the pixel values available in frame buffer 670. The display signals generally need to be compatible with the implementation of projector 130. In one embodiment, display generator 680 sends the RGB and synchronization signals (for horizontal and vertical directions) to scan/refresh the system image (using, for examples, standards such as video graphics array (VGA) and digital video interface (DVI), well known in the relevant arts), and projector 130 in response projects the same image on screen 140. Display generator 680 and frame buffer 670 may be implemented in a known way.

Runtime environment 610 facilitates access of various resources (including communication interface 640, implement interface 650 and mouse interface 660) to presentation application 420 and other applications 430. The run time environment may contain the operating system, device drivers, etc., and are shared by all the user applications executing in digital processing system 100. Runtime environment 610 may contain various routines/procedures, which can be invoked by the respective user application for accessing/using the corresponding resource.

As relevant to the illustrative example, when pixel values and control signals are received and buffered by communication interface 640, runtime environment 610 may receive an interrupt requesting processing of the buffered data. Runtime environment 610 may examine the data (e.g., the TCP port) to determine that the buffered data is to be provided to implement interface 650. The buffered data is according transferred to the appropriate recipient. It should be appreciated that some other data elements may be received directed to the user applications (based on TCP port number), and the data is accordingly delivered to the user application.

Similarly, runtime environment 610 also receives the mouse events from mouse interface 660 and provides the mouse events to the corresponding target application (presentation application 620, other applications 630, operating system, etc.). The specific target application is generally determined based on the location on the screen at which the mouse action is performed. For example if a user performs a right click at pixel (302, 308), the application controlling that particular pixel location is considered to be the target application. The target application is notified of the specific mouse action, and the application processes the action according to a pre-specified design.

Implement interface 650 processes the information (pixel values representing image frames and control signals generated by pressing keys 361-363) received from handheld 110 overpath 111. The pixel values representing image frames are processed by implement interface 650 to detect the location of the beam spot in the image frame, for example, as described above in step 220.

In response to receiving control signals corresponding to keys 362 and 363, implement interface 650 may pass the location information determined above, along with the indication of the specific mouse action (either right click or left click in the illustrative example) to mouse interface 660 for further processing.

On the other hand, in response to receiving a control signal indicating that a presenter has pressed key 361, implement interface 650 may write appropriate values in corresponding locations of frame buffer 670 to super-impose a visible mark at the detected location (on the display image) of the beam spot. Assuming that the system image is also mapped to the same coordinate space in the above example, the memory location in frame buffer 670 may be overwritten with a value corresponding to the visible mark. The color/intensity value corresponding to the visible mark may also be chosen such that the resulting display (a point on line 411) of the mark at that point is also clearly visible to the viewers.

For example, for an image with a resolution of 640 by 480 (generally referred to as VGA or Versatile Graphics Adapter resolution), assuming one location (e.g., a byte or 24 bits) of frame buffer 670 (memory) per pixel, frame buffer 670 may use 307200 bytes (generally referred as location 0 to location 307199) to store a system image. Assuming that the pixels may be accesses sequentially, counting from top left pixel identified as pixel (0,0), and moving down progressively and counting from left to right, the memory count of a pixel may be computed as (640*(line number−1)+column number).

Assuming that implement interface 650 has detected the location of a beam spot as (200,100) in terms of pixel coordinates in a display image with VGA resolution, to change the nature of pixel at (200,100) i.e. column 200 and line 100, the memory location corresponding to byte 6600 may be written into. Assuming that storing a value “10” makes the pixel visible, implement interface 650 may write the value “10” into memory location corresponding to byte 6600 in frame buffer 670 to make pixel (200, 100) visible. It may be appreciated that the beam spot may be detected as an area (for example a circle with a specified centre and radius) as described above, and it may be necessary to set the values of all the pixels in the detected area to equal the visible mark.

By super-imposing visible marks at successive locations of the beam spot, implement interface 650 may create a persistent line (or other shapes) in the system image being projected by projector 130. Implement interface 650 may also connect two successive locations of the beam spot with visible marks, to fill up any gaps, and to create a smooth persistent line (or other shapes).

It may be appreciated that once the values for pixels are written into a location in frame buffer 670, they may remain there till an application over writes the frame buffer to correspond to a new application image. Therefore, once a line (or other shapes) is super-imposed in the system image being projected on screen 140 (by writing appropriate values in corresponding locations of frame buffer 670), the line (or other shapes) may remain (be persistent) till the application image is changed (for example, when the presenter changes the slide being presented).

The description is continued with the architecture of handheld 110, according to an embodiment of the present invention.

8. Pointer Implement Architecture

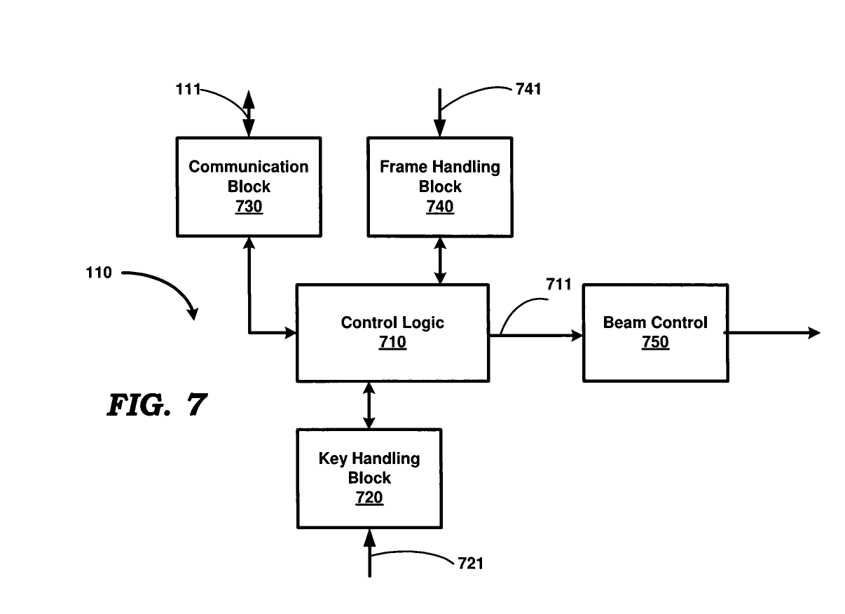

FIG. 7 is a block diagram illustrating an architecture for a handheld (example pointer implement), in an embodiment of the present invention. Handheld 110 is shown containing control logic 710, button handling block 720, wireless communication block 730, frame handling block 740, and configuration tables 750. Each block is described in further detail below.

Again, merely for illustration, only representative number/types of blocks are shown in FIG. 7. However, architecture according to several aspects of the present invention can contain many more/fewer/different blocks, both in number and type, depending on the purpose for which the environment is designed, as will be apparent to one skilled in the relevant arts.

Communication block 730 provides connectivity between handheld 110 and digital processing system 120 over path 111. Communication block 730 forwards digital data received from digital processing system 120 to control logic 710 and transmits digital data (pixel values representing image frames and control signals representing pressing of keys 361-363) received from control logic 710 to digital processing system 120 over path 111. Communication block 730 maybe implemented as a wired or wireless interface, in a known manner.

Frame handling block 740 receives pixel values representing an image frame from camera 320 and forwards the pixel values to control logic 710 for onward transmission to digital processing system 120 though wireless communication block 730 over path 111 at least when a user operates key 361. Frame handling block 740 may be implemented in a known manner.

Key handling block 720 interfaces with the keys (keys 360-363 and keys in portion 350) of handheld 110. When a key is pressed, key handling block 720 (after processing such as de-bouncing, etc.) provides data identifying the key pressed to control logic 710. Beam control 750 controls the specific time durations in which light source 310 sends a beam of light based on the control signals received from control block 710.

Control logic 710 operates to support the functioning of the various blocks in handheld 110, noted above. Thus, with respect to image frames, the pixel values received from camera 320 through frame handling block 740 are sent to communication block 730 for forwarding to digital processing system 120 over path 111 when key handling block indicates that key 361 is operated by a user.

Control logic 710 generates appropriate control signals on path 711 to cause beam control 750 to turn on/off the beam of light in response to indication of the operation of key 360 (received from key handling block 720). With respect to data received from key handling block 720 identifying keys 361-363 pressed, control logic 710 generates corresponding control signals and sends the control signals to communication block 730 for forwarding the control signals along with the image frame to digital processing system 120.

It should be appreciated that digital processing system 120 can be implemented with a desired combination of software/hardware and firmware as suited for the specific scenario. The description is continued with respect to an embodiment in which several features of the present invention are operative upon execution of appropriate software instructions.

9. Software Implementation

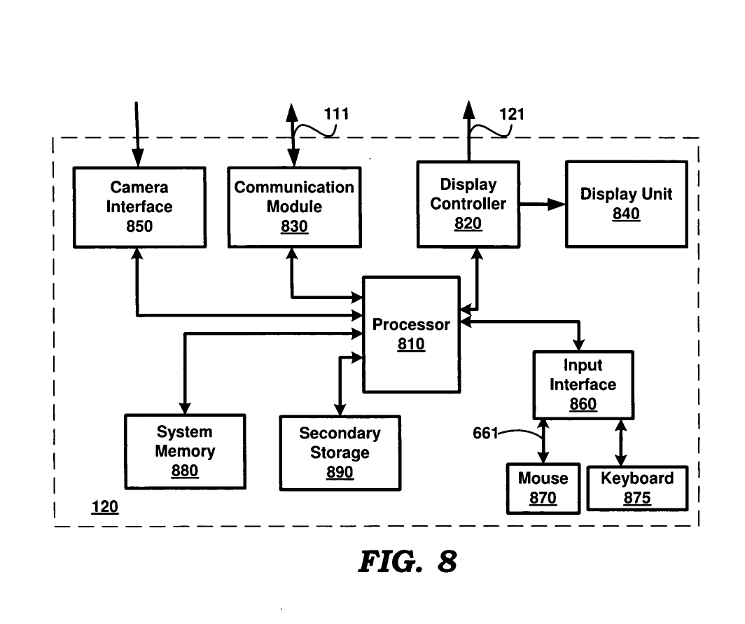

FIG. 8 is a block diagram illustrating the details of a digital processing system in an embodiment of the present invention. System 800 is shown containing processor 810, display controller 820, display unit 840, communication module 830, camera interface 850, input interface 860, mouse 870, keyboard 875, system memory 880 and secondary storage 890. Each block is described in further detail below.

Once again, merely for illustration, only representative number/type of blocks are shown in FIG. 8. However, digital processing system 120 according to several aspects of the present invention can contain many more/fewer/different blocks, both in number and type, depending on the purpose for which the environment is designed, as will be apparent to one skilled in the relevant arts. For example, digital processing system 120 may contain camera interface 850 only if a camera may be connected to digital processing system 120.

System memory 880 contains randomly accessible locations to store program (instructions) and/or data, which are used by processor 810 during operation of digital processing system 120. The data and instructions may be retrieved from secondary storage 890. The data retrieved may correspond to various application data such as a presentation, etc. System memory 880 may contain RAM (e.g. SRAM, SDRAM, DDR RAM, etc.), non-volatile memory (e.g. ROM, EEPROM, Flash Memory, etc.) or both.

In general, processor 810 may execute the instructions using the data (both in secondary storage 890) to enable digital processing system 120 to provide enhanced presentation capabilities using a pointer implement.

Secondary storage 890 may store (on a non-volatile memory) the data and software instructions, which enable digital processing system 120 to provide several features in accordance with the present invention. Secondary storage 890 may be implemented using persistent memory such as hard drives, flash memory, removable storage drives, etc., and represents a computer readable medium from which instructions can be read and executed by processor 810 to provide several features of the present invention.

Display controller 820, based on data/instructions received from CPU 810, generates the system image (e.g., in RGB format) to projector 130 over path 121, and display unit 840. In an embodiment, display controller 820 contains frame buffer 670 and display generator 680. Display unit 840 contains a display screen to display the images (e.g., portions of screens depicted in FIG. 4) defined by the display signals.

Input interface 860 enables input/output devices such as pointing devices (for example, mouse 870), keyboard 875, etc. to be connected to digital processing system 120. Mouse actions (including those by other pointer devices) such as mouse clicks and mouse movement generated by mouse 870 may be provided to mouse interface 660 over path 661 through input interface 860. Mouse 870 and keyboard 875 may be used to provide inputs to applications (for example, presentation application 620, other applications 630, etc.) executing in digital processing system 120.

Camera interface 850 captures the image frame of a display image as pixel values through a camera (not shown). In an embodiment, digital processing system 120 interfaces with the camera to capture the image frames on screen 140, and camera interface may accordingly receive the image frames. In such an embodiment, the pointer implement need not be implemented with camera 320.

Communication module 830 represents an interface which provides connectivity between handheld 110 and digital processing system 120 over path 111. Communication module 830 provides the physical (connector, antenna, etc.), electronic (transmitter, receiver, etc.) and protocol (IEEE 802.11 standards, USB, etc.) interfaces necessary for handheld digital processing system 120 to communicate with handheld 110 over path 111. Communication module 330 may be implemented in a known manner.

Processor 810 at least in substantial respects controls the operation (or non operation) of the various other blocks (in digital processing system 120) by executing instructions stored in system memory 880. Some of the instructions executed by processor 810 also represent various user applications (e.g., presentation application 620, other applications 630, etc.) provided by digital processing system 120.

In general, processor 810 reads sequence of instructions from various types of memory medium such as system memory 880 and executes the instructions to provide various features of the present invention. Processor 810 interfaces with the other components described above, to enable a pointer implement to provide enhanced presentation capabilities. Processor 810 may be implemented with one or more processing units (each potentially adapted for a specific task) executing the software instructions.

Thus, using techniques above, a presenter may use a handheld device, operating co operatively with a digital processing system, as a pointer implement to provide enhanced presentation capabilities, such as drawing persistent lines, providing mouse clicks to an application executing in the digital processing system, etc.

7. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A presentation system comprising:
a screen to display a display image;
a projector to receive a system image on a first path and project said system image on said screen;
a pointer implement to produce a beam of light, said beam of light forming a beam spot on a location of said screen when said pointer implement is pointed to said screen by said user, wherein said system image and said beam spot together forming said display image; and
a digital processing system to provide said system image to said projector and to examine said display image to determine said location of said beam spot on said screen.

2. The presentation system of claim 1, wherein said projector is provided external to said digital processing system.

3. The presentation system of claim 1, wherein said pointer implement captures said display image and provides said display image to said digital processing system for said examination.

4. The presentation system of claim 3, wherein said pointer implement provides said display image in the form a plurality of pixel values, wherein said digital processing system examines said pixel values to determine said location of said beam spot on said screen.

5. The presentation system of claim 4, wherein said digital processing system executes a user application which generates an application image for display on said screen, said digital processing system superimposing a visible mark at said location on said application image to form said system image, wherein said system image is provided to said projector for display on said screen.

6. The presentation system of claim 5, wherein said pointer implement comprises a first key,
wherein said digital processing system receives a first control signal from said pointer implement requesting that said visible mark be superimposed at said location on said application image in response to operation of said first key,
wherein said digital processing system superimposes said visible mark in response to receiving said first control signal from said pointer implement,
whereby a user can control said superimposition by operating said first key to generate said first control signal.

7. The presentation system of claim 6, wherein said digital processing system receives a sequence of display images including said display image in response to said user operating said first key at corresponding time instances,
said digital processing system also receiving a sequence of control signals including said first control signal,
wherein each of said sequence of control signals indicates that a corresponding one of said sequence of display images contains a beam spot at a corresponding location and that a visual mark at the location is to be superimposed on said application image,
wherein said digital processing system superimposes a sequence of visible marks including said visible mark on said application image to form said system image in response to receiving said sequence of display images and said sequence of control signals.

8. The presentation system of claim 7, wherein said digital processing system comprises:
a frame buffer into which said user application writes a second plurality of pixel values representing said application frame; and
a implement interface block to overwrite some of said second plurality of pixel values in said frame buffer with said sequence of visible marks in response to receiving said sequence of control signals.

9. The presentation system of claim 8, wherein said sequence of visible marks represents a contiguous line.

10. The presentation system of claim 4, wherein said pointer implement comprises a second key which when operated by a user causes said pointer implement to send a second control signal associated with said display image to said digital processing system,
wherein a mouse event corresponding to said location is generated in said digital processing system in response to said second control signal.

11. The presentation system of claim 10, wherein said digital processing system comprises:
a mouse interface to receive said second control signal and said location, and generates said mouse event corresponding to said location;
a run-time environment receiving said mouse event corresponding to said location and to cause an action to be executed in said digital processing system in response.

12. The presentation system of claim 11, wherein said location is on a close window location and said action comprises closing a window displayed in said display image.

13. The presentation system of claim 11, wherein said location is in a menu location and said action comprises displaying an expanded menu.

14. A pointer implement comprising:
a light source to generate a beam of light in a direction;
a camera to capture an image frame in said direction; and
a communication block to transfer said image frame on a path to an external system.

15. The pointer implement of claim 14, further comprising:
a set of keys; and
a processor to cause said communication block to transfer said image frame on said path when any of said keys is operated upon by a user.

16. The pointer implement of claim 15, wherein said set of keys includes a first key which when operated causes said processor to said a first control signal associated with said image.

17. The pointer implement of claim 16, wherein said first control signal indicates that a visible mark be superimposed on an application image at a location of a beam spot caused by said beam of light to form said image frame, said application image being generated by an application executing in said digital processing system.

18. The pointer implement of claim 17, wherein said set of keys includes a second key which when operated causes said processor to generate a second control signal associated with said image, wherein a digital processing system is designed to generate a mouse event at said location in response to receiving said second control signal.

19. A machine readable medium storing one or more sequences of instructions for causing a system to provide enhanced presentation features to a user using a pointer implement, wherein execution of said one or more sequences of instructions by one or more processors contained in said system causes said system to perform the actions of:
receiving an image frame representing a display image present on a screen, said image frame containing a beam spot; and
examining said image frame to determine the location of said beam spot in said image frame,
wherein said beam spot is formed on said screen by a beam of light produced by said pointer implement when said pointer implement is pointed to said screen by said user.

20. The machine readable medium of claim 19, wherein said image frame is received in the form a plurality of pixel values, wherein said examining examines said pixel values to determine said location of said beam spot on said screen.

21. The machine readable medium of claim 20, further comprising:
executing a user application which generates an application image for display on said screen;
superimposing a visible mark at said location on said application image to form a system image; and
sending said system image for display on said screen,
wherein said image present on said screen contains at least a portion of said system image sent to said screen.

22. The machine readable medium of claim 21, further comprising:
receiving a first control signal associated with said image frame indicating that said visible mark be superimposed at said location on said application image;
wherein said system superimposes said visible mark in response to receiving said first control signal.

23. The machine readable medium of claim 22, further comprising:
receiving a sequence of display images and a sequence of control signals, said sequence of display images including said display image, and said sequence of control signals including said first control signal,
wherein each of said sequence of control signals indicates that a corresponding one of said sequence of display images contains a beam spot at a corresponding location and that a visual mark at the location is to be superimposed on said application image,
wherein said digital processing system superimposes a sequence of visible marks including said visible mark on said application image to form said system image in response to receiving said sequence of display images and said sequence of control signals.

24. The machine readable medium of claim 22, further comprising:
receiving a second control signal associated with said display image,
wherein a mouse event corresponding to said location is generated in said digital processing system in response to said second control signal.
